(19) United States
(12) Patent Application Publication
(10) Pub. No.: US 2018/0266576 A1
(43) Pub. Date: Sep. 20, 2018

(54) Fluid Valve With Hysteresis

(71) Applicant: AQUALONE, NOUMEA cedex (FR)

(72) Inventor: Bernard Balet, Noumea Cedex (FR)

(21) Appl. No.: 15/768,721

(22) PCT Filed: Oct. 14, 2016
(86) PCT No.: PCT/FR2016/052662

§ 371 Date: Apr. 16, 2018

(30) Foreign Application Priority Data
Oct. 14, 2015 (FR) 1559775

(51) Int. Cl. F16K 15/06; F16K 17/04

(52) U.S. Cl. CPC F16K 15/066; F16K 17/048

(57) ABSTRACT

A needle valve capable of adopting at least one closed position and one open position, a piston sensitive to the fluid flow and able to adopt at least one low-flow position and one high-flow position. The needle valve and the piston are arranged in such a way that as long as the piston is in the high flow position, the needle valve is prevented from occupying the closed position.

### FIELD OF THE INVENTION

The invention relates to valves which permit the passage of a fluid. The invention also relates to irrigation of ground.

### BACKGROUND OF THE INVENTION

In order to direct the flow of the fluid in a system comprising a plurality of ducts, it is known to use a valve which is controlled electrically per duct, and an electrical programmer.

Thus, the electrical programmer can make the valves which are controlled electrically go from a closed position to an open position, and conversely. The programmer can thus direct the flow of fluid in the system.

For example, in the case of agricultural ground to be irrigated, ground of this type is habitually divided into at least two successive distinct areas relative to the flow of water available. Two ducts supplied with water are thus installed, branched from a main duct. A valve which is controlled electrically, or solenoid valve, is also installed between the main duct and each output of the branched ducts. An electrical programmer is then installed which can close and open the solenoid valves.

In order to irrigate each area sequentially, the programmer opens a solenoid valve, whilst keeping the other solenoid valve closed. Thus, plots of the agricultural ground are irrigated periodically. The electrical connection between the electrical programmer and the solenoid valve is mostly formed by at least one electric wire.

However, the operating conditions of agricultural or horticultural exploitation, and more generally the humid environment in which a system of this type operates, can damage the electric wires and detract from the quality of the electrical connection between each electrical programmer and its solenoid valve. In addition, it is necessary to supply the programmer and the solenoid valve with electrical energy. Finally, the use of electric wires prevents the programmer and the solenoid valve from being positioned at a distance of more than a few tens of meters away, unless long-length electrical connections are provided which would reduce even further the reliability of the system.

In addition, in general, the use of electric wires and more generally of electric current, is ill-suited for the presence of fluid, and in particular liquid.

### SUMMARY OF THE INVENTION

An objective of the invention is thus to provide a valve which can be controlled without using electrical energy.

For this purpose, according to the invention, a fluid valve with hysteresis is provided, comprising:
a valve which can adopt at least one closed position and one open position;
a piston which is sensitive to the flow of fluid, which can adopt at least one low-flow position and one high-flow position, characterized in that the valve and the piston are arranged such that, for as long as the piston is in the high-flow position, the valve is prevented from occupying the closed position.

Thus, by controlling fluidically the piston which is sensitive to the flow of fluid, it is possible to control the position of the valve, and thus the opening or closure of the fluid valve with hysteresis. In addition, since the piston which is sensitive to the flow of fluid can retain the valve in the open position, it is possible to establish a condition of opening of the valve different from the closure condition. This provides the valve with a hysteretic nature, and, in the case of a plurality of valves installed on the same network, makes it possible to prioritize the opening of one valve to the detriment of the others.

Preferably, the piston which is sensitive to the flow comprises a surface which forms a support for the valve, in order to retain the valve in the open position.

The size of the valve is thus reduced.

Advantageously, the valve comprises means designed such that the valve goes from the closed position to the open position when the fluid pressure exceeds a predetermined threshold.

According to one embodiment, the means designed such that the valve goes from the closed position to the open position when the fluid pressure exceeds a predetermined threshold comprise at least a piston, a seal, and preferably a spring and a screwed knob.

Preferably, the means designed such that the valve goes from the closed position to the open position when the fluid pressure exceeds a predetermined threshold comprise at least one membrane.

These are simple means for configuring the pressure threshold.

Advantageously, the valve comprises means designed such that the piston which is sensitive to the flow is in the high-flow position when the fluid pressure exceeds the predetermined threshold, and that an output of the valve is in a position of passage of the fluid.

Preferably, the valve comprises means designed such that the piston which is sensitive to the flow remains in the high-flow position when the fluid pressure has dropped below the predetermined threshold, for as long as the valve output remains in the position of passage of the fluid.

This is a simple means for putting the hysteresis of the valve into place.

According to one embodiment, the valve comprises a spring which makes it possible to retain the piston which is sensitive to the flow in the low-flow position.

The invention also comprises a fluid control valve with hysteresis comprising:
a fluid control valve with a main duct and a control output; and
a fluid valve with hysteresis as previously described, connected to the control output of the fluid control valve.

Thus, it is possible to control the opening and closure of the fluid control valve by means of the valve with hysteresis.

The invention also comprises a fluid control with hysteresis comprising:
a fluid valve with hysteresis as previously described; and
a fluid control connected to the output of the fluid valve with hysteresis.

Thus, it is possible to control the fluid valve with hysteresis by means of a fluid control. The fluid valve with hysteresis is therefore controlled by the demands for fluid of the area to be supplied with fluid.

Finally, the invention comprises a system for supply of fluid comprising:
at least one fluid control valve with hysteresis as previously described;
at least one fluid control with hysteresis as previously described, characterized in that the fluid control valve with hysteresis and the fluid control with hysteresis comprise a common fluid valve with hysteresis.

### BRIEF DESCRIPTION OF THE DRAWINGS

A non-limiting description will now be provided of two embodiments of the invention, by means of the following figures:

FIG. 1 is an exploded view in cross-section of a fluid valve with hysteresis according to an embodiment of the invention;

FIGS. 2 to 5 are views in cross-section of this valve in different positions of opening and closure;

FIG. 6 is a view in cross-section of a valve according to a second embodiment of the invention;

FIG. 7 is a view in cross-section of a fluid control valve with hysteresis; and

FIG. 8 is a view in cross-section of a fluid control with hysteresis according to the invention.

### DETAILED DESCRIPTION OF THE INVENTION

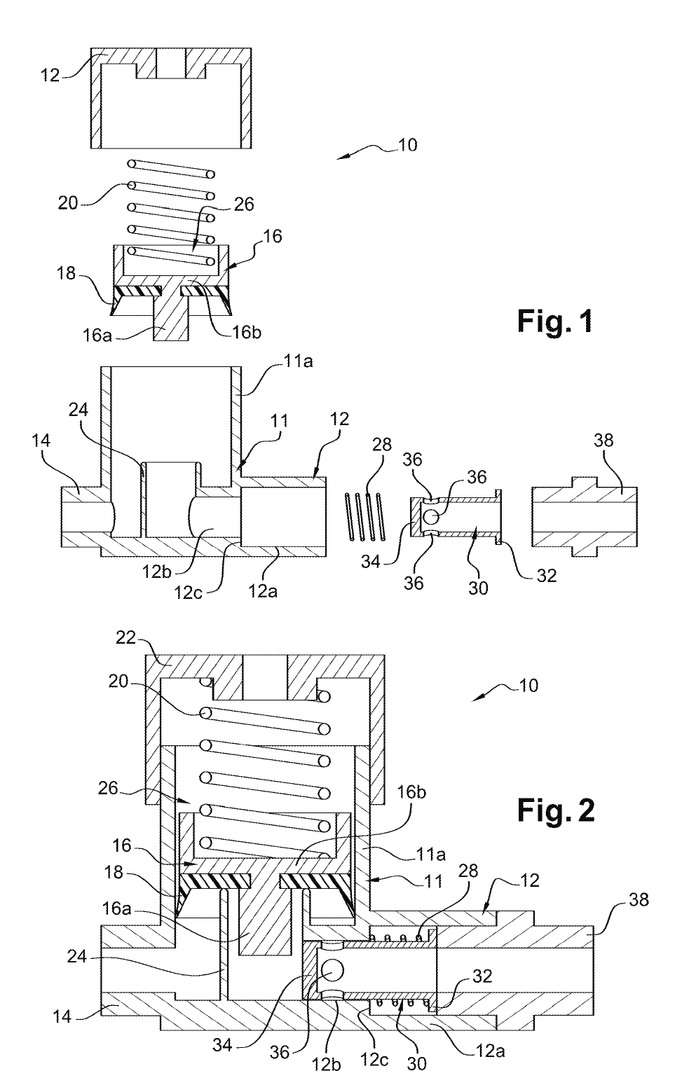

FIGS. 1 and 2 represent a fluid valve with hysteresis 10 according to the invention.

Throughout the description, use is made indiscriminately of the terms “flux” and “flow” which are considered to be synonymous within the context of the invention.

The fluid valve with hysteresis 10 comprises a body 11, formed by a shaft 11a, which in this case is globally cylindrical, provided at its base with a fluid input channel 12 and a fluid output channel 14. In this case, the fluid input channel 12 and the fluid output channel 14 are on the same axis, which is perpendicular to that of the shaft 11a. The fluid valve with hysteresis 10 is thus a valve with a straight body. According to a variant of this embodiment, the fluid valve with hysteresis 10 comprises an angle body.

The fluid valve with hysteresis 10 also comprises, accommodated in the shaft 11a, a first piston 16, a unit which forms a seal 18, a first spring 20 and a knob 22 screwed onto the shaft 11a around the first spring 22, and which extend according to the axis of the shaft 11a, i.e. in this case perpendicularly to a direction of circulation of fluid between the fluid input 12 and the fluid output 14. The body 11 comprises a fluid circulation chamber 24, an end of which forms the seat of the seal 18, as can be seen in particular in FIG. 2, in order to prevent the fluid obtained from the fluid input 12 from reaching the fluid output 14 when said seal 18 is supported on its seat.

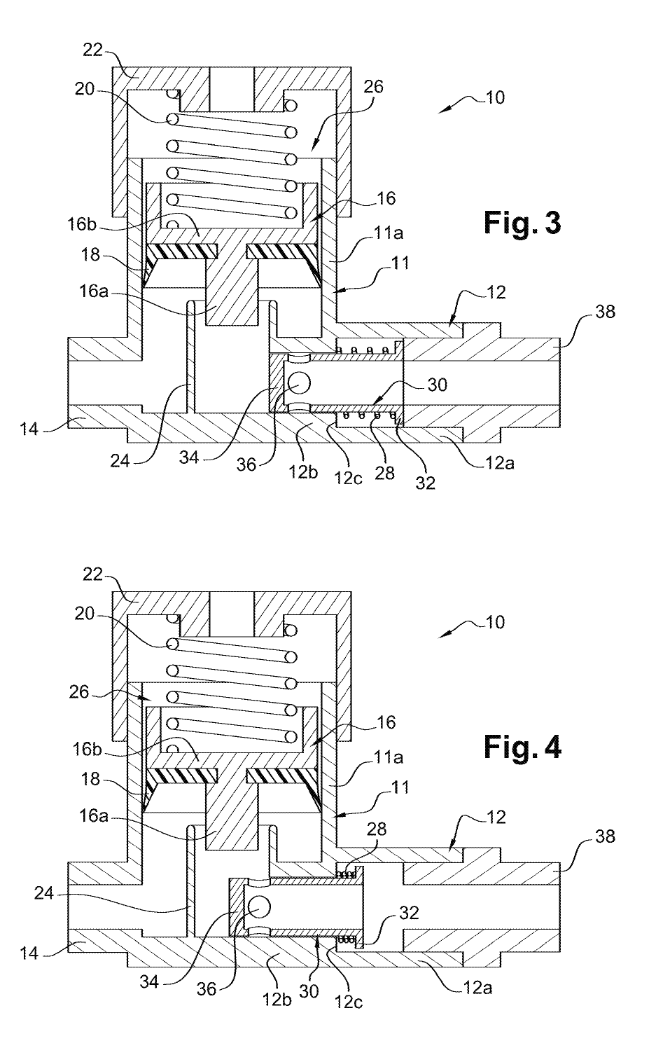

In this case, the first piston 16, the seal 18, the first spring 20 and the knob 22 form, together with the fluid circulation chamber 24 of the body 11, a valve 26 which can adopt at least a closed position, shown in FIG. 2, and an open position, shown in particular in FIG. 3. By tightening the knob 22 to a greater or lesser extent on the shaft 11a around the first spring 20 which is supported on the first piston 16, the tension of the spring is defined, and thus a fluid pressure threshold which is more or less high, on the basis of which the fluid passes through the valve.

When the fluid pressure at the input 12 is lower than this threshold, the first spring 20 is supported on the first piston 16, and applies the seal 18 against the end of the fluid circulation chamber 24 of the body 11, such as to retain the valve 26 in the closed position, as can be seen in FIG. 2.

On the contrary, when the fluid pressure at the input 12 exceeds this predetermined threshold, the first spring 20 is compressed by the fluid. The seal 18 is then no longer supported against the end of the fluid circulation chamber 24 of the body 11. The fluid can thus flow from the fluid input 12 to the fluid output 14, as illustrated in FIG. 3. The valve 26 is then in the open position.

Thus, the fluid valve with hysteresis 10 comprises means which are designed such that the valve 26 goes from the closed position to the open position when the fluid pressure exceeds a predetermined threshold. In this case, these means comprise the first piston 16, the seal 18, the first spring 20 and the knob 22.

It should be noted that the first piston 16 comprises a stud 16a which fulfils two functions, i.e. firstly it retains the seal 18 in an annular groove 16b situated at its base, and secondly it occupies a volume in the fluid circulation chamber. This last function will be explained in relation with a second piston 30 of the fluid valve with hysteresis 10.

In fact, the fluid valve with hysteresis 10 comprises a second spring 28 and a second piston 30, which are accommodated in the input channel 12. The input channel 12 comprises two sections, i.e. an upstream section 12a and a downstream section 12b with a smaller diameter than the upstream section 12a, separated by a shoulder 12c.

The second piston 30 is a hollow cylindrical body, in other words with a longitudinal inner channel, comprising a base 34 at one of its ends and an outer collar 32 at its opposite end. The base 34 is placed downstream in the direction of circulation of the fluid, whereas the collar 32, around the open end, is placed upstream. As can be seen in particular in FIG. 2, the second spring 28 is engaged around the second piston 30, and the outer collar 32 acts as a seat for the second spring 28. The end opposite the second spring 28 is supported on the shoulder 12c of the input channel 12.

In the vicinity of the base 34, the second piston 30 comprises a plurality of orifices 36, the purpose of which will be described hereinafter.

The fluid valve with hysteresis 10 comprises a joining piece 38 which fulfils two functions, i.e. on the exterior it acts as a connection for piping (not represented) which is connected to the fluid valve with hysteresis, and on the interior it acts as a stop for the outer collar 12 of the second piston, in order to retain the latter in the body. The joining piece 38 is hollowed by a longitudinal channel which prolongs the longitudinal inner channel of the second piston.

The second piston 30 is mobile by means of axial translation in the body 11, between two end positions, depending on whether the outer collar 12 is supported on the joining piece 38 or on the second spring 28 which is compressed against the shoulder 12c.

Since the outer diameter of the second piston 30 is slightly smaller than the inner diameter of the duct which surrounds it, the second piston 30 leaves around itself a gap which allows the fluid to pass through it irrespective of the position of the piston. The second piston thus never prevents the passage of the fluid which enters the valve via the fluid input 12.

Thus, the second piston 30 transmits to the first piston 16 the pressure of the fluid which is present in the input channel 12.

Because of its configuration, the second piston 30 is sensitive to the flow of fluid passing through the input channel 12.

In fact, as long as the flow of fluid is lower than a threshold defined by the calibration of the second spring 28, the second piston is in a position of relaxation which can be seen in particular in FIGS. 2 and 3.

When the flow of fluid exceeds the predetermined threshold, the second piston 30 is driven downstream and compresses the second spring 28, as represented in FIG. 4. In this case, the fluid obtained from the fluid input 12 flows directly into the fluid circulation chamber 24, through the orifices 36. The losses of load are thus reduced, and the passage of the fluid is therefore further facilitated, which tends to maintain, or even increase its flow.

When the second piston 30 is in the high-flow position, it occupies part of the inner volume of the fluid circulation chamber 24, in which chamber the stud 16a of the first piston 16 is also accommodated.

Thus, the second piston 30 is sensitive to the flow of fluid, and can adopt at least a low-flow position and a high-flow position. In addition, the fluid valve with hysteresis 10 comprises means, in this case the second spring 28, which are designed such that the piston 30 which is sensitive to the flow is in the high-flow position when the flow of fluid exceeds a predetermined threshold.

In addition, even if the fluid pressure drops back below the predetermined pressure threshold, for as long as the fluid output 14 of the fluid valve with hysteresis 10 is open, and the flow is sufficient, the piston 30 is retained in the high-flow position. This is because of the fact that, when the fluid flows with a high flow rate, it keeps the second spring 28 compressed.

In order for the second spring 28 to return to its position of relaxation, it is necessary for the flow of the fluid to decrease once more, independently from the pressure of the fluid.

A description will now be provided, with reference to FIGS. 2 to 5, of the operation of the fluid valve with hysteresis 10.

The fluid valve with hysteresis 10 is designed to receive all types of fluid, i.e. a gas or a liquid. In this embodiment, the fluid valve with hysteresis 10 is designed to receive a liquid such as water.

When the fluid pressure is lower than a predetermined threshold, the fluid valve with hysteresis 10 is in its position represented in FIG. 2. The valve 26 is in the closed position, which has the consequence that the flow of fluid is zero, and the second piston 30 is in the low-flow position.

Thus, for as long as the fluid pressure at the input of the fluid valve with hysteresis 10 is lower than the predetermined threshold, the fluid cannot reach the fluid output 14 of the fluid valve with hysteresis 10.

When the fluid pressure exceeds the predetermined threshold, but the fluid output 14 is closed, for example because another valve (not represented), situated downstream, is closed, the fluid valve with hysteresis 10 adopts the position represented in FIG. 3. The valve 26 is in the open position, but the piston 30 is still in the low-flow position, since the fluid is not circulating. The fluid occupies the fluid circulation chamber 24, but cannot leave the fluid valve with hysteresis 10.

When the fluid pressure exceeds the predetermined threshold and the fluid output 14 is open, the fluid valve with hysteresis 10 adopts the position represented in FIG. 4. The valve 26 is in the open position, and the second piston 30 is in the high-flow position.

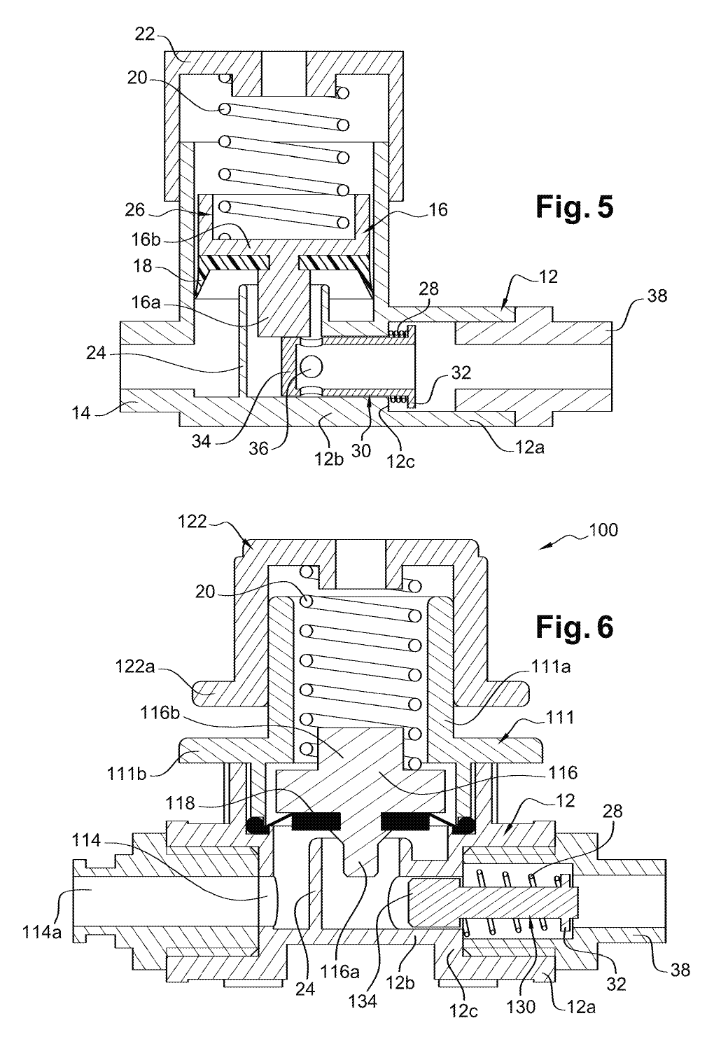

When, because for example of the opening of the fluid output 14, the pressure of the fluid drops back below the predetermined pressure threshold, the fluid valve with hysteresis 10 adopts the position represented in FIG. 5. The second piston 30 is still in the high-flow position, since the fluid output 14 is open. Thus, since the second piston 30 which is sensitive to the flow of fluid is occupying part of the fluid circulation chamber 24, it impedes the re-descent of the piston 30, the stud 16a of which cannot enter sufficiently far into said chamber 24. In other words, the second piston comprises a surface which forms a support for an end of the first piston 16, i.e. in this case the stud 16a and the first piston 16 can no longer apply the seal 18 on the complementary end of the fluid circulation chamber 24. Thus, the valve 26 is retained in the open position.

The valve 26 and the piston 30 are thus arranged such that, for as long as the piston 30 is in the high-flow position, the valve 26 is prevented from occupying the closed position.

In order for the fluid valve with hysteresis 10 to return to the position represented in FIG. 2, the fluid output 14 must be closed.

Thus, even when the fluid pressure has dropped back below the threshold, the fluid valve 10 is open for as long as the fluid output 14 is not closed. This is why it can be classified as a fluid valve with hysteresis 10.

In addition, since it is the closure of the fluid output 14 which determines the end of the flow of fluid in the fluid valve with hysteresis 10, the flow ends when the device which is situated downstream from the fluid valve with hysteresis 10 no longer requires fluid.

An advantageous use of the valve according to the invention consists of placing at least two fluid valves with hysteresis 10 on two parallel ducts supplied by a main duct. Thanks to the two fluid valves with hysteresis, it is possible to prioritize the supply of one of the ducts. In fact, by tightening the knob 22 to a greater or lesser extent, a more or less high pressure threshold is defined, and there is determination of which of the two valves will open first.

When the pressure exceeds the predetermined threshold in the two valves, but only the fluid output 14 of one of the fluid valves with hysteresis 10 is open, the piston 30 which is sensitive to the flow of the latter goes into the high-flow position, and thus prevents the valve 26 from occupying the closed position. Thus, even if the pressure drops in the main duct because of the high flow in one of the fluid valves with hysteresis 10, the latter will remain in the high-flow position, whilst preventing the opening of the fluid output 14 of the other fluid valve with hysteresis 10. In fact, by allowing the fluid to flow, the open fluid valve with hysteresis 10 will maintain the pressure in the main duct at a low level. This is why the other fluid valve with hysteresis 10 will be able to have its fluid output 14 going into the open position only when the first fluid valve with hysteresis 10 has closed its fluid output 14.

FIG. 6 represents a fluid valve with hysteresis 100 according to a second embodiment. Only the differences from the first mode will be described. The elements which are unchanged retain the same numerical references.

In this case, the seal 18 has been replaced by a reinforced sealed membrane 118. The piston 116 has a form slightly different from that of the piston 16, but has the same functional parts. The same applies to the knob 122. Thus, in this embodiment, the means which are designed such that the valve goes from the closed position to the open position when the fluid pressure exceeds a predetermined threshold comprise the membrane 118, the piston 116, the spring 20 and the knob 122.

In this case, the second piston 130 comprises a downstream section 134, the diameter of which is larger than that of an upstream section of the piston body 130. Thus, when the latter is in the low-flow position, the gap between the downstream section 134 of the piston and the upstream section 12b of the input channel 112 is minimal. On the contrary, when the piston 130 is in the high-flow position, the gap between the upstream section of the piston 130 and the downstream section 12b of the input channel 12 is larger, which permits higher flows of fluid. In this case, the piston 130 does not comprise fluid circulation orifices 36.

In addition, the screwed knob 122 and the shaft 111a comprise complementary stops, respectively 122a and 111b, such as to define a maximal pressure threshold, for example in order to preserve the intactness of the fluid valve with hysteresis 100. In fact, when the complementary stops 122a and 111b come into contact with one another, it is no longer possible to tighten the screwed knob 122 around the first spring 20.

In addition, in this embodiment, a connection joining piece 114a is arranged in the fluid output channel 114 of the body 111, in order for example to connect the fluid valve with hysteresis 100 to an appropriate fluid device (not represented).

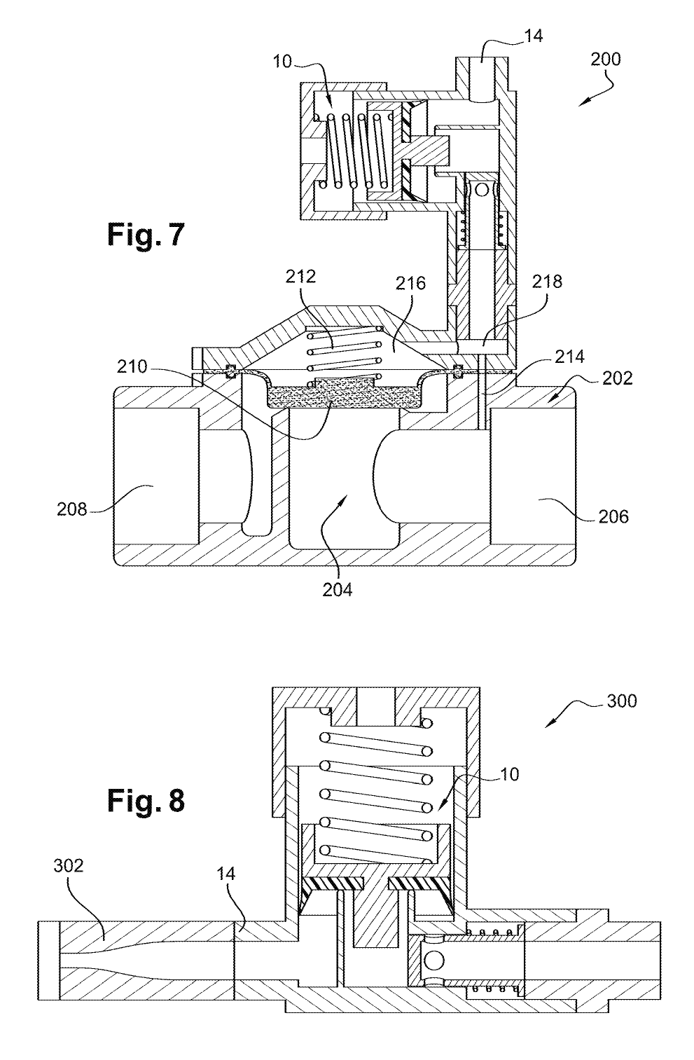

FIG. 7 represents a fluid control valve with hysteresis 200.

The fluid control valve with hysteresis 200 comprises a fluid control valve 202. This fluid control valve 202 comprises a body 204 which in this case forms a main fluid duct. The main fluid duct comprises an upstream duct 206 and a downstream duct 208. A sealed membrane 210 is arranged between the upstream duct 206 and the downstream duct 208. A spring 212 thrusts the sealed membrane such that it is supported on its seat. In addition, the fluid control valve 202 comprises, arranged branched from the upstream duct 206, a duct 214 which leads to a chamber 216 delimited by the sealed membrane 210, and in which the spring 212 is arranged. In addition, the duct 214 is connected to a control output 218 of the fluid control valve 202.

The fluid valve with hysteresis 10 is connected to the control output 218 of the fluid control valve 202. Consequently, the fluid valve with hysteresis is subjected to the pressure of the fluid present in the upstream duct 206, at least for as long as the output of the fluid valve with hysteresis is closed. The regulation of the knob of the fluid valve with hysteresis must be such that the pressure of the fluid in the upstream duct 206 is sufficient to open the valve of the latter.

For as long as the fluid output 14 of the fluid valve with hysteresis 10 is closed, the fluid obtained from the upstream duct 206 passes via the duct 214, and regains the chamber 216, where its pressure on the sealed membrane ensures the retention of the latter on its seat, and consequently closure of the fluid control valve 202.

When the fluid output 14 of the fluid valve with hysteresis 10 opens, the pressure of the fluid in said fluid valve with hysteresis drops, but since the piston which is sensitive to the flow has been displaced downstream in order to accompany the increase in flow of the fluid, the fluid valve with hysteresis remains open.

The drop in pressure of the fluid is propagated to the chamber 216. The pressure of the fluid on the membrane on the channel input side 206 then becomes greater, and the membrane is detached from its seat. The fluid obtained from the upstream duct 206 can then regain the downstream duct 208.

Thus, the circulation of fluid in the fluid control valve 202 depends on the circulation of fluid in the fluid valve with hysteresis 10.

FIG. 8 shows schematically a fluid control with hysteresis 300. The fluid control with hysteresis 300 comprises the fluid valve with hysteresis 10 as previously described, and a fluid control 302 which is connected to the fluid output 14 of the fluid valve with hysteresis 10. In this embodiment, the fluid control 302 is a tap. According to variants, the fluid control 302 is an autonomous irrigation control device which can open and close when the device calculates that irrigation needs to be carried out.

In order to form a fluid supply system, a fluid valve with hysteresis 10 is used which forms part both of a fluid control with hysteresis 300 as previously described, and of a fluid control valve with hysteresis 200, also as previously described.

It will be appreciated that numerous variants may be applied to the invention without departing from its context.

For example any type of knob can be used to define the predetermined pressure threshold of the valve 26.

The fluid valve with hysteresis 10 can also be associated with any type of fluid device.

1. A fluid valve with hysteresis, comprising:
a valve which can adopt at least one closed position and one open position;
a piston which is sensitive to the flow of fluid, which can adopt at least one low-flow position and one high-flow position,
wherein the valve and the piston are arranged such that, for as long as the piston is in the high-flow position, the valve is prevented from occupying the closed position, the valve and the piston being two distinct parts.

2. The valve as according to claim 1, wherein the piston which is sensitive to the flow of fluid comprises a surface which forms a support for the valve, in order to retain the valve in the open position.

3. The valve according to claim 1, comprising a means designed such that the valve goes from the closed position to the open position when the fluid pressure exceeds a predetermined threshold.

4. The valve according to claim 3, wherein the means designed such that the valve goes from the closed position to the open position when the fluid pressure exceeds a predetermined threshold comprises at least a piston, and a seal.

5. The valve according to claim 3, wherein the means designed such that the valve goes from the closed position to the open position when the fluid pressure exceeds a predetermined threshold comprises at least one membrane.

6. The valve according to claim 1, comprising a means designed such that the piston which is sensitive to the flow is in the high-flow position when the fluid pressure exceeds the predetermined threshold, and that an output of the valve is in a position of passage of the fluid.

7. The valve according to claim 6, comprising the means designed such that the piston which is sensitive to the flow of fluid remains in the high-flow position when the fluid pressure has dropped below the predetermined threshold, for as long as the valve output remains in the position of passage of the fluid.

8. The valve according to claim 1, comprising a spring which retains the piston which is sensitive to the flow in the low-flow position.

9. The valve of claim 1 being connected to a control output of a
a fluid control valve, the fluid control valve further including a main duct.

10. The valve of claim 1 further comprising an output and being connected to a fluid control at the output to create a fluid control with hysteresis.

11. A system for supply of fluid comprising:
at least one fluid control valve with hysteresis comprising
a valve which can adopt at least one closed position and one open position;
a piston which is sensitive to the flow of fluid, which can adopt at least one low-flow position and one high-flow position, wherein the valve and the piston are arranged such that, for as long as the piston is in the high-flow position, the valve is prevented from occupying the closed position, the valve and the piston being two distinct parts;
the at least one fluid control valve with hysteresis being connected to a control output of a fluid control valve, the fluid control valve further comprising a main duct;
the at least one fluid control with hysteresis comprises an output and is connected to a fluid control at the output to create a fluid control with hysteresis wherein the fluid control valve with hysteresis and the fluid control with hysteresis comprise a common fluid valve with hysteresis.

12. The valve according to claim 4 wherein said means further comprises a spring and a screwed knob.

13. The valve according to claim 4, wherein the means designed such that the valve goes from the closed position to the open position when the fluid pressure exceeds a predetermined threshold comprises at least one membrane.
